(19) United States
(12) Patent Application Publication
(10) Pub. No.: US 2010/0312383 A1
(43) Pub. Date: Dec. 9, 2010

(54) INTERACTIVE MULTIFUNCTIONAL SYSTEM FOR PACKAGED-PRODUCT AUTHENTICATION AND REAL-TIME PRODUCT DISPENSATION INFORMATION

(75) Inventors: Praful Ramachandra Naik, Honavar (IN); Mohan Harakachand Bhandari, Pune (IN)

Correspondence Address: VIERING, JENTSCHURA & PARTNER, 3770 HIGHLAND AVE., SUITE 203, MANHATTAN BEACH, CA, 90266, US

(73) Assignee: BILCARE LIMITED, Pune (IN)

(21) Appl. No.: 12/676,610

(22) PCT Filed: Sep. 4, 2008
(86) PCT No.: PCT/IN08/00564

§ 371 Date: Mar. 5, 2010

(30) Foreign Application Priority Data
Sep. 6, 2007 (IN) 1702/MUM/2007

(51) Int. Cl. G06F 17/00; G06Q 10/00; G07F 11/00

(52) U.S. Cl. 700/242; 705/2; 221/5

(57) ABSTRACT

The invention relates to an interactive system comprising of a primary device interacting with user and working in conjunction with at least one other multifunctional device providing authentication of a package containing a product and optionally one or more of package registration, product dispensation and recording real-time product dispensation information and facilitating user compliance with a pre-determined regime. The system comprises of a multifunctional device comprising reader means for reading unique identification information related to the product package, communication means, and optionally one or more of dose sensing means for detecting the presence of the product in the package, dose dispensing means, user interactive means and data storage means; a primary device in communication with the multifunctional device comprising communication means adapted to receive information related to the product package from the said multifunctional device and being capable of conveying the information to a remote system or an external device.

### FIELD OF THE INVENTION

The present invention relates to an interactive system for authenticating a package containing a product and optionally dispensing the product or a packaged-product. In particular the invention relates to a comprehensive system comprising of a primary device interacting with the user and working in conjunction with at least one other multifunctional device providing authentication of a package containing a product and optionally one or more of package registration, product dispensation and recording real-time product dispensation information and facilitating user compliance with a pre-determined regime. Optionally the system may communicate product dispensation and user or product usage related information via the said primary device to an external device for information processing and management.

### BACKGROUND ART

Packaging is a major interface between a manufacturer and the user. Counterfeiting has become a growing social evil of disproportionate dimensions that needs to be tackled at multiple points of interactions in the marketplace. In this regard packaged-product authentication at the consumer end or point of use of the product by the consumer would play a significant role. Further in using a product in accordance with a pre-determined regime, the consumer compliance is an area of concern especially with products related to healthcare as non-compliance with respect to prescriptions may lead to secondary and tertiary effects that have grave consequences on a person's overall health and well being. The patient compliance and feedback plays a significant role in clinical research/trials as they provide insight by way of pharmacovigilance into the drug/medicine under development. There is therefore an urgent need to provide packaging that cannot be easily counterfeited and/or provide packaging solutions so that the consumer is able to easily identify counterfeits. In addition to packaged-product authentication, it is desirable to provide systems that facilitate product dispensation and real time recording of product dispensation to help a user to achieve compliance to a set consumption plan or pre-determined regime. Further devices automatically capturing real time product usage data and integrating the same into a healthcare system would enable online and off line assistance to a user as and when necessary.

Several efforts have been made in the past to provide partial solutions to the above-mentioned consumer needs.

U.S. Pat. No. 7,249,687 discloses a medicament dispenser. It comprises of a medicament dispenser for use with a medicament carrier having multiple distinct medicament doses carried and an internal mechanism for dispensing the distinct medicament doses carried by the medicament carrier. The mechanism comprises receiving means for receiving the medicament carrier; release means for releasing a distinct medicament dose from the medicament carrier on receipt thereof by the receiving means; an outlet, positioned to be in communication with the medicament dose releasable by the release means; indexing means for individually indexing the distinct medicament doses of the medicament carrier; and counting means for counting each time a distinct medicament dose of the medicament carrier is indexed by the indexing means. The counting means is a distinct electronic counter unit that is reversibly receivable by the medicament dispenser. This is a self contained single function packaging system that can record the product dispensation in real time but does not directly help the consumer to achieve compliance as per a prescription. Further there is no built in system for package authentication against counterfeiting nor does it have any communication system to integrate this device with any healthcare system.

US Patent Application 20060184271 discloses an automatic prescription pill dispensing unit using a cartridge in which prescription drugs are pre-loaded, preferably by a pharmacist, according to the user's medication regimen. This tamper-proof cartridge can only be unlocked by a pharmacist using a specially designed loading dock, or by inserting the cartridge into the user's dispensing unit. Undesirably, the consumer would seem to have to visit the pharmacy every time he has to get his cartridge refilled. There is no provision for product authentication or real time sensing and/or detection of the product dispensation. There is no provision for integrating such a system in any healthcare system.

US Patent Application 20050030163 discloses a medicine dispenser. It comprises of dispensing device for dispensing medication including a habitually used mechanism for being used habitually by a patient and a medication dispensing mechanism for dispensing medication at the times of the use of the habitually used device. This is a mere dispenser of a habitually used product such as a toothbrush with an alarm arrangement which is triggered by the toothrush removal reminding the user to take his medicine.

This device does not have the capability of any package-product authentication and cannot form a part of any healthcare system.

EP1006982 discloses a medicament dispense sensing device to register the dispensing of medicaments comprising sensing devices located at the medicament side to detect the dispensing thereof. The device is comprised of a sheet-like envelope of a one-way material and being a continuous, foldable way adapted to enclose the medicaments. There is an electronic printed circuit applied on the envelope and is stretched over foldable areas of the sheet-like envelope. It is also operatively connected to the sensing devices and to an electronic unit. The sheet records the removal of the medicament as a result of the break in the electronic circuit. This has no capability for authentication of the product nor can it provide a means for compliance.

Indian patent application number 171/mum/2006 discloses package-companion-user interactive system wherein an array of signal generating means and signal sensing means are provided in the companion device to receive and reflect signals generated by the signal generating means to sense presence/absence of product in the package. In one embodiment, this system provides an array of signal generating means in the companion device working in conjunction with signal sensing means. In this device the said plurality of generated signal is reflected to sense the presence/absence of product in the package. This system provides a means for package authentication using the companion device but is not capable of real time recording of the product dispensation time.

The Indian Patent Application 34/MUM/2006 discloses interactive smart package with an associated device for anti-counterfeit and compliance measures wherein there is a smart system comprising product package with signal generating means and an associated device that facilitates detection of the presence or absence of product/s in the package. This system also provides for package authentication using the companion device working in conjunction with some other external devices.

It is desirable to provide a user friendly system that obviates the use of signal generating provisions on the unit dose package yet allows the product to be authenticated to reduce the risk of counterfeit. It is also desirable to provide at least one of product dispensing, sensing and quantitatively recording the product removal from the package, registration of the package, authentication of the package, communication capability with external device and compliance functions for example patient feedback from clinical trials and/or collection of pharmacovigilance data to provide comprehensive cost effective solutions to provide compliance assistance to the user and/or clinical researcher.

### SUMMARY OF THE INVENTION

An object of the invention is to provide a comprehensive system comprising of a primary device working in conjunction with at least one other multifunctional device providing package-authentication and preferably providing at least one of registration, product dispensation and recording real-time product dispensation information and facilitating user compliance. User compliance desirably includes acquiring appropriate patient feedback from clinical trials and/or collection of pharmacovigilance data. A further object suitably includes communicating product dispensation and user/product usage related information for example pharmacovigilance related information in clinical trials via the said primary device to external device/s for information processing and management. It is a further object of the invention to provide a multifunctional device for controlled dispensing of a plurality of packaged unit dose(s) also capable of working in conjunction with the said primary device.

Another object of the invention is to provide a system which obviates the provision of signal generating means corresponding to product containments in a unit dose package.

Yet another object of the invention is to obviate the need for placement or insertion of the unit dose package in a companion device to sense the presence or absence of the product in the package.

Yet another object of the invention is to obviate the need for a signal generating or reflecting means in the companion device to sense the presence or absence of the product in the package.

Another object of the invention is to provide a system to sense, record and transmit real time product dispensing information to an external device and optionally authenticate the packaged-product.

Yet another object of the invention is to provide a system to authenticate the package containing the product and optionally sense, record and transmit real time product dispensing information to an external device. The system suitably provides package authentication without necessarily requiring the dispensation of the packaged product at the same time as authenticating the package

Yet another object of the invention is to identify and establish a package as a non-authentic package after the validity period/expiry period has elapsed and/or after the entire contents of the package have been dispensed

Yet another object of the invention is to provide a user friendly device with a system that is capable of dispensing the product from the unit dose package, records the real time product dispensing event and communicates the product and product dispensing information to external devices.

It is yet another object of the invention to facilitate user compliance for example appropriate patient feedback from clinical trials and/or collection of pharmacovigilance data, and optionally communicating product dispensing and user/product usage related information for example pharmacovigilance related information in clinical trials.

Yet another object of the invention is to provide a child-safe multifunctional dispensing system for controlled dispensing a packaged unit dose or a plurality thereof.

Thus one aspect of the invention provides a system

for use in authenticating a product package containing a product and information related to the product package
the system comprising:
i) a multifunctional device comprising:
reader means for reading information related to the product package communication means, and optionally one or more of dose sensing means for detecting the presence of the product package, dose dispensing means, user interactive means and storage means for storing information relating to the dispensing of product from the product package; and;
ii) a primary device in communication with the said multifunctional device comprising communication means adapted to receive information related to the product package from the said multifunctional device and being capable of conveying the information to a remote system or an external device.

The communication means may be wired or wireless.

In a further aspect, the invention provides a system for use in authenticating a product package containing a product and information related to the product package comprising) a product, preferably a unit dose, a package comprising one or plurality of containment/s adapted to receive the product optionally with a closure, and information related to the product package, preferably a chip or a randomized unique pattern/code or RFID (radio-frequency identification) ii) a multifunctional device comprising reader means for reading the information related to the product package, communication means, and optionally one or more of dose sensing means for detecting the presence of the product package, dose dispensing means, user interactive means and storage means; and;
iii) a primary device in communication with the said multifunctional device comprising communication means adapted to receive information related to the product package from the said multifunctional device and being capable of conveying the information to a remote system or an external device.

Suitably, the storage means is employed for storing information relating to the dispensing of product from the product package, the medication dose regime etc.

In a further aspect, the invention provides an anti-counterfeit interactive system suitable for providing effective solution to anti-counterfeiting and providing compliance assistance to the end user comprising:
i) a product package comprising one or a plurality of containment adapted to receive a product optionally with a closure and the product package carrying identification information for verifying the identity of the product package;

ii) a system comprising;
a multifunctional device and a primary device in communication with the said multifunctional device
said multifunctional device comprising;
dose sensing means for detecting the presence of the product package;
reader means for detecting identification information carried by the product package, communication means for communicating information from the dose sensing means and/or reader means to the primary device; and
said primary device comprising;
communication means adapted to receive information related to the product package from the said multifunctional device and optionally adapted to convey the same to a remote system or an external device.

Preferably the product package comprises one or more unit dose packages. The information relating to the product package may relate to one or more of the unit dose packages.

The multifunctional device, remote system or external device suitably comprises, one or more of a data storage means, data processing means and user interactive means.

The multifunctional device preferably comprises packaged unit dose dispensing means and provides for controlled dispensing of one or a plurality of packaged unit dose(s). The dose sensing means detects the presence of the product package in proximity to the multi-functional device and suitably records information relating to the time at which the product package is brought into proximity with the multi-functional device or is engaged with the dose dispensing means.

The reader means is suitably able to detect the identification information relating to the product package and conveys the information or generates a signal in response to the information which is communicable to the primary device. Suitably, the information is encoded and preferably is optical, electronic or magnetic.

The multifunctional device may comprise any conventional reader means to detect the encoding information identifying the product package. The information or signal may be stored in the multi-functional device or primary device or conveyed to a remote system or external device.

The multifunctional device and the primary device may be present as separate devices or may be combined or integrated in a single housing such that the function of both devices is provided by a single piece of equipment. In a preferred embodiment, the primary device may be a mobile telephone and the multifunctional device for detecting the identification information of the unit dose package may be integral with the telephone such that the multifunctional device is integrated with the communication means of the telephone whereby the identification information may be conveyed to a remote system or external device. Advantageously, this arrangement means the user need carry only one piece of equipment.

The present invention allows the product package to be verified or authenticated thereby reducing economic drawbacks and health risks associated with counterfeit products. Unique identifying information is suitably included on the package in the form of oriented or orientable particles and may relate to for example, the manufacturer of the package or to an individual. Preferably the identification information comprises information derived from a magnetic field and/or an electric field and optionally optical or magneto-optical information.

In a preferred embodiment, the product package suitably comprises a substantially non-magnetic host material having pores, wherein at least some of the pores contain a substantially magnetic material which is codable to encode identification information for identifying the product package or a unit dose package. The product package or unit dose package may comprise a substantially electrically-insulating host material having pores, wherein at least some of the pores contain a substantially electrically-conducting material which is codable to encode identification information for identifying the unit dose package. Desirably, the electrically-conducting material is connectable to a voltage source.

In an especially preferred embodiment, the host material and the magnetic or electrically-conducting material contained in the pores of the host material are as described in WO2005/008294, the contents of which are incorporated herein by reference. Suitably, the unit dose packaged-product comprises a tag as described in WO 2005/008294.

In a further aspect, the invention provides a system for use in authenticating a product package containing a product and two or more unique product identifers related to product package the system comprising:
i) a multifunctional device comprising reader means for reading one or more of the unique product identifiers, communication means, and optionally one or more of dose sensing means for detecting information related to the product package, dose dispensing means, user interactive means and storage means ; and
ii) a primary device in communication with the said multifunctional device comprising a communication means adapted to receive information related to the unique identifiers from the said multifunctional device and being capable of conveying the information to remote system or an external device.
wherein the identity of the product package is verified to authenticate the same by providing the package with at least two sets of identification information comprising a first set of identification information and a second set of identification information, wherein at least one identification feature of the first set of identification information is arranged on or incorporated within a different surface, side or plane of the package, with respect to at least one identification feature of the second set of identification
   information, thereby adapting the package to be identified,
wherein said at least one identification feature of the first set of identification information and said at least one identification feature of the second set of identification information are arranged at a fixed relative spatial position with respect to each other, said fixed relative spatial position being used to derive a signature for identifying the package;
wherein the reader means comprises of one or more reading elements arranged to correspond to the position of each set of identification information on the package for reading the at least two sets of identification information;
wherein the said reader means is adapted to read a signal from the at least one identification feature of each of the at least two sets of identification
   information arranged on or incorporated within different surfaces, sides or planes of the package, and wherein the reading device is configured such that it defines the spatial relationship between a first discrete area of the first set of identification information to be read and a second discrete area of the second set of identification information to be read, and determining, using the reading device, at least one characteristic of a property of the at least one identification feature of the first set of identification features, thereby obtaining a first signal, determining, using the reading device, at least one characteristic of a property of the at least one identification feature of the second set of identification features, thereby obtaining a second signal, using a processing unit to derive/form/generate at least one signature for the object, using said first and said second signals (and thereby inherently or explicitly the features' spatial relationship).

In one of the embodiments the identification information may comprise an identification layer in which, at least in part, a plurality of randomly distributed particles is present. The randomly distributed particles may comprise a material that displays one or more consistently measurable physical properties, such as magnetic field strength, capacitance or conductance wherein “randomly distributed particles” includes voids, bubbles, or magnetic domains with a continuous material, or regions of varying reflectivity, or electrical properties.

In another embodiment the product package is provided with an identification tag for identifying the package for authentication. The tag comprises at least two sets of identification information, said at least two sets of identification information comprising a first set of identification information and a second set of identification information each arranged within a different surface, side or plane of the identification tag, and identification features of said first set of identification information and identification features of said second set of identification information are arranged at a fixed relative spatial position with respect to each other, said fixed spatial relationship being used for identifying the object.

In another aspect the invention provides an anti-counterfeit interactive system for providing effective solution to anti-counterfeiting and providing compliance assistance to the end user comprising:
i) a product package comprising one or plurality of containment/s adapted to receive a product optionally with a closure and the product package carrying two or more unique product identifiers related to the product package;
   ii) a system comprising;
a multifunctional device and a primary device in communication with the said multifunctional device
said multifunctional device comprising;
dose sensing means for detecting the presence of the product package;
reader means for detecting one or more of the unique product identifiers carried by the product package;
communication means for communicating information from the dose sensing means and/or reader means to the primary device and optionally
   dose dispensing means; and
said primary device comprising;
communication means adapted to receive information related to the unique identifiers from the said multifunctional device and being capable of conveying the information to a remote system or an external device.

The identifiers may be present in a tag on the product package. One identifier may comprise a readable layer of randomly distributed material which is capable of encoding identification information, for example a conductive material, magnetized or magnetisable material, semiconductive particle and optically active particles.

The second identifier suitably comprises optical information, for example a 1-D or 2-D bar code. The unique product identifiers are suitably recorded in an external device or remote system, primary device or multi-functional device such that on bringing the product package into proximity with the multi-functional device, for example by swiping the product package along a groove in a multifunctional device, the reader means detects the presence or absence of the unique product identifiers on the product package, conveys information relating to them to the primary device and optionally to a remote system or external device wherein the acquired information from the product package is compared with that recorded so as to verify or authenticate the product package. The product sensing means suitably records information relating to the time at which the product package is brought into proximity with the multi-funtional device and this is suitably conveyed to the primary device and optionally to an external device or remote system and compared with a pre-determined regime to determine user compliance or otherwise with the pre-determined regime.

The reader means is capable of capturing information from one of the unique product identifiers which is suitably coded in the tag. Further reader means, for example a visible identifier sensor suitably reads a second unique product identifier, for example a barcode or a hologram. Preferably, the multi-functional device comprises a digitizer to convert the analog signal from the reader means and/or product sensor means to digital data. The data may be manipulated prior to or after communication to the primary device and optionally may be encrypted for example using a crypto-processor.

Encryption is suitably achieved by conventional means for example using software or hardware for example in the form of IBM 4758 SoC, Intel LaGrande, TI M-Shield.

In a preferred embodiment, the primary device acquires encrypted data from the multi-functional device by an exclusive pairing mechanism with the reader means and suitably communicates the data to an external device or remote system, for example an authentication server. Suitably the external device or remote system transmits a signal to the primary device relating to the product package and its authenticity.

The remote system or external device suitably comprises an authentication server which receives data, preferably encrypted, relating to the two unique product identifiers from the primary device, decrypts the data where appropriate and compares the received data with stored data relating to the product package and desirably a pre-determined product consumption regime preferably using a proprietary algorithm known in the art.

In a preferred embodiment, the data received by the external device or remote system comprises a unique number retrieved from a visual unique product identifier, for example a barcode and information relating to the second unique product identifier. The external device or remote system suitably matches the received data to the stored data for the same visual unique identifier. If the data matches, data relating to the product package is retrieved and sent to the primary device. Preferably, the primary device formats the received data and displays the same to the user seeking the authenticity of the product. If the data is not matched, the remote system or external device preferably sends data to the primary device to the effect that the “product package is not authentic”.

### DETAILED DESCRIPTION OF THE INVENTION

Features and advantages of this invention will become apparent in the following detailed description and the preferred embodiments with reference to the accompanying drawings.

The term “Product” as employed herein includes material in liquid, solid, semi-solid, powder, aerosol, emulsions or their combinations and which is preferably packed, wrapped, encompassed, encased, contained in or completely surrounded in or by a package either in unit doses or in a combination of unit doses.

The term “Unit dose” as employed herein includes a unit of a product contained in singular package containment

The term “Package” as employed herein includes a product containment portion or holding cavity in a material, preferably formed or made using a laminate and optionally including a closure for the containment or cavity. The containment or cavity may be formed by a flexible laminate or material wherein a part of the same laminate or material is sealed to form a pouch for containing or holding the product.

The term “Packaged product” as employed herein includes a product in a packed state.

The term “Packaged-product” as employed herein includes a packed one or plurality of unit dose of product.

The term “Compliance” as employed herein includes a patient's (or doctor's) adherence to a recommended course of treatment using the product.

The term “Pharmacovigilance” as employed herein includes the pharmacological science relating to the detection, assessment, understanding and prevention of adverse effects, particularly long term and short term side effect of medicines. Generally speaking pharmacovigilance is the science of collecting monitoring, researching, assessing and evaluating information from healthcare providers and patients on the adverse effects of medications.

The term “remote system” as employed herein includes devices such as servers, central processing units and communication devices.

The terms “information related to identity of the package” and reference to the “status of the package” includes information related to authentication of the package to identify and confirm the source of the package and access information such as manufacturing date, expiry date, place of manufacture, geographical validation in that area and the like.

The invention is further described with reference to the non-limiting accompanying drawings which show:

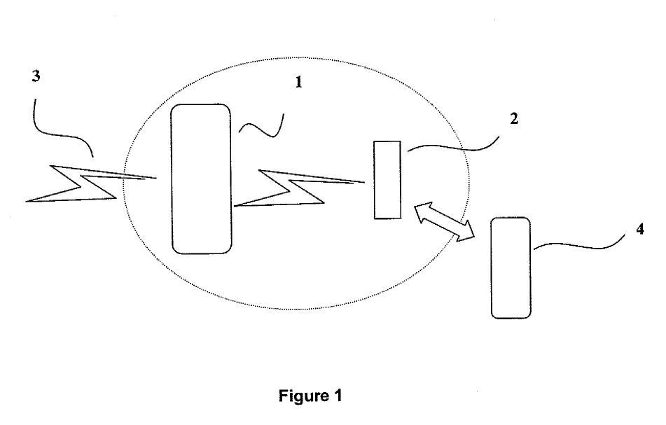

FIG. 1 Schematic of the system (Sheet 1)

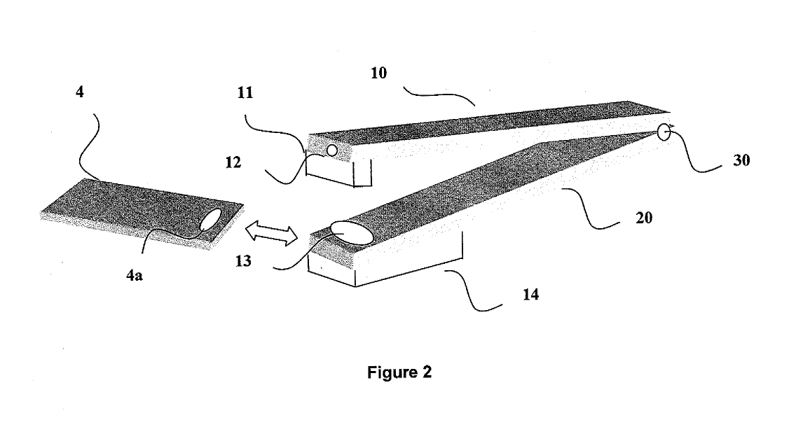

FIG. 2 Schematic of the dispense-reader device (Sheet 2)

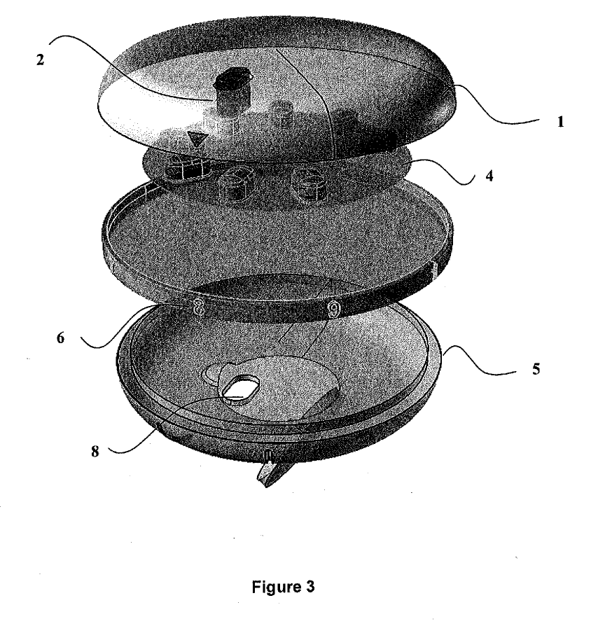

FIG. 3 Schematic of the dispense-reader device (Sheet 3)

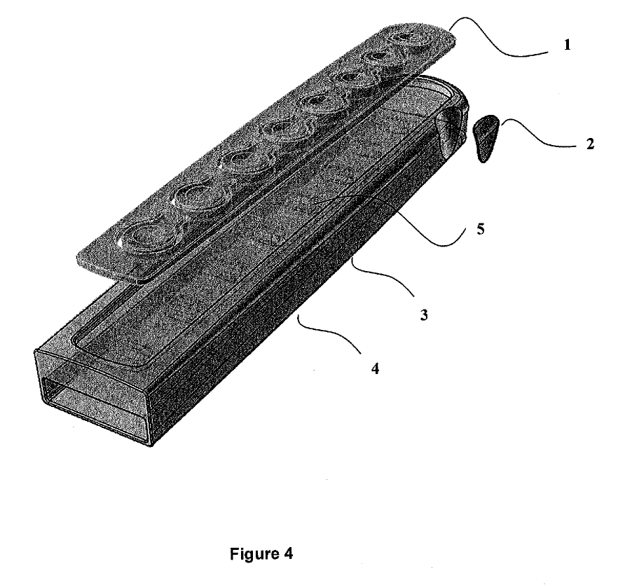

FIG. 4 Schematic of the dispense-reader device (Sheet 4)

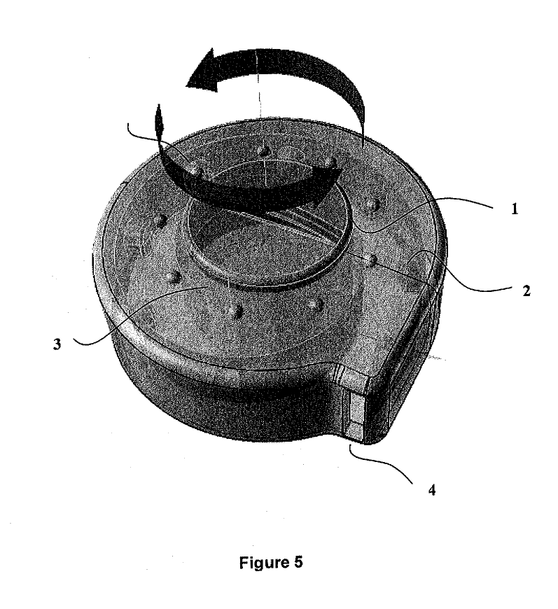

FIG. 5 Schematic of the dispense-reader device (Sheet 5)

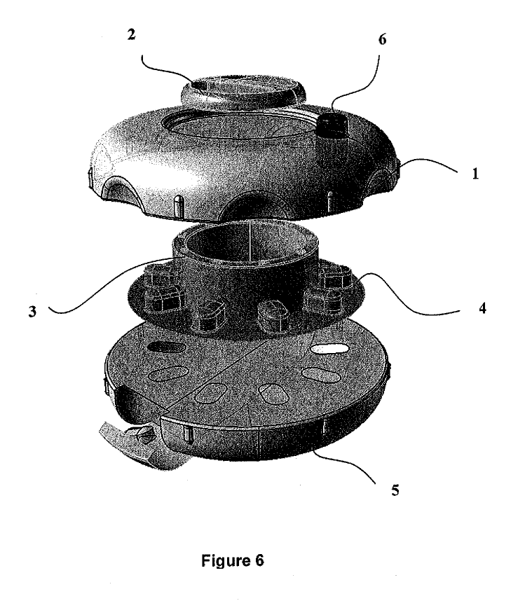

FIG. 6 Schematic of the dispense-reader device (Sheet 6)

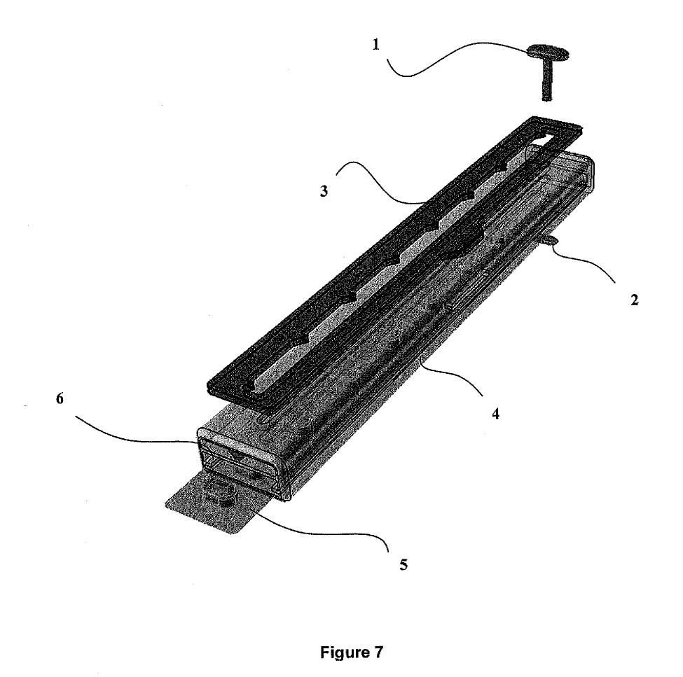

FIG. 7 Schematic of the dispense-reader device (Sheet 7)

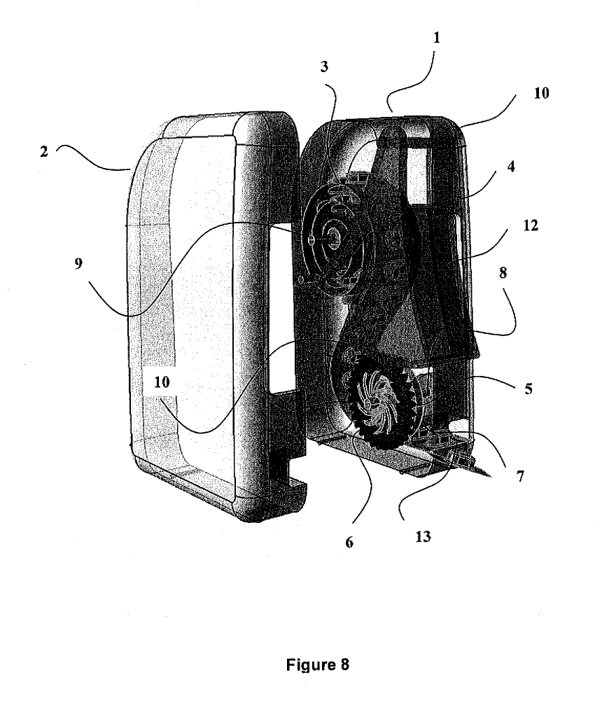

FIG. 8 Schematic of the dispense-reader device (Sheet 8)

The FIG. 1 illustrates the system configuration. It comprises of the primary device 1 that is adapted to interact with the user and work in conjunction with at least one multifunctional device 2. In one of the embodiments the said primary device is capable of communicating with external devices (indicated by 3) by wired and/or wireless mode. The multifunctional device 2 is adapted to dispense, read and record the product information from the package 4 that is provided with a chip or randomized unique patterns/code or RFID means that contains information related to product package. The primary device 1 comprises of a wired or wireless communication means and user interactive means (not shown) adapted to receive information from the said multifunctional device and/or user feedback on the effects of the medication including during clinical trials, research or pharmacovigilance to optionally convey the same to external device. The said primary device 1 further includes a data storage and data processing means. Further, there can be plurality of the said multifunctional devices.

In a preferred embodiment, the said multifunctional devices suitably comprises a first movable elongate member hinged to a second optionally movable elongate member wherein the said first member has a protrusion at the end opposite to the hinged end under the surface that faces the second elongate member; a reader means adapted to read and acquire information from the said randomized unique pattern/code or chip of the package, communication means, data storage means, user interactive means; the said second member comprises an opening disposed at the end opposite to the hinged end corresponding to the protrusion of the first member, with an optional conduit following the said opening, an outlet to the said conduit; sensing means disposed on the said first elongate member or in/along the said conduit; wherein the said package when positioned between the said members allows the location of the product containment of the package below the protrusion of the said first member; thereby on application of appropriate force on the end provided with protrusion of the said first elongate member, dispensing the product from the containment of the package optionally into the conduit through the said opening of the said second member; wherein the said sensing means senses and records the real time product dispensation.

A preferred embodiment of the multi-functional device comprises a dispenser housing adapted to contain packaged unit doses; a means for controlled advancing of the said packaged unit doses, for example a rail, pathway, channel or lamina; optionally a means to force the product unit dose out of the said package to dispense the same; an opening for guiding and dispensation of the said product unit dose or the product;
a means for locking the advancement of the product unit doses in the said advancement means, a means for unlocking the advancement of the product through the said advancement means; optionally unit product dose sensing means configured with communication means, user interactive means, data storage means, reader means adapted to integrate in the said housing of the system.

FIG. 2 illustrates a further embodiment of the multifunctional device for a blister package. It comprises of first and second elongate members 10 and 20 respectively that are hinged at one end (30). The end that is opposite to the hinged end of the first elongate member is provided with a protrusion 11 under the surface facing the second elongate member as shown in the figure. Corresponding to the said protrusion, there is positioned an opening 13 on the second elongate member 20 as shown in the Figure. A conduit 14 is disposed below the said opening is provided with outlet provision (not shown). In one of the embodiments the said conduit is optional. In other embodiment, the product sensing means (not shown) is disposed in the said conduit 14 to sense the dispensation of the product. In another embodiment the said conduit is removable and detachable from the said second member 20. This is preferably used when the unit dose is in the powder form. In another embodiment, the sensing means is disposed near the protrusion 11.

The first member is provided with a reader 12 that is used to read, acquire the information from the chip or randomized pattern/code of the package. Further, the first member 10 is adapted to fit communication means, data storage means, user interactive means (not shown) that are configured with the said sensing means.

Preferably, the dose sensing means is selected from a mechanical trigger, a lever switch, a push button, for example a micro push button, a cam switch, an optical switch, a reflective LED_Transistor, LDR (Light Intensity). In yet another variant the dose sensing means is Color. In yet another variant it is Optical. Encoder that includes Circular Disc. In yet another variant it is Optical Encoder based on linear detection methods.

A further embodiment is depicted in FIG. 3. The device comprises of a dispenser housing that is divided in a top compartment 1 and bottom compartment 5 as shown in the figure. A packaged unit dose/s controlled advancing means in the form of a rotatable lamina 4 is adapted to fit between the said compartments such that it can rotate independently. The said lamina is provided with markings (indicated by 6), preferably time/date of product consumption etc. along the periphery. The packaged unit dose/s is disposed on the top of the said lamina 4 such that the pack also rotates upon rotation of 4. The said top compartment 1 is provided with a spring loaded pressing means 2 such that it can be aligned on the top of the individual blister. The bottom compartment is provided with an opening 8 for dispensing the product from the blister. The said two compartments and the said lamina 4 are rotated in tandem with each other. During operation the user has to align the said pressing means 2 and the said opening 8 with respect to the said marking 6. Upon pressing the said means 2, the product from the packaged unit dose/s is dispensed from the said opening. In one of the embodiments said compartments 1 and 2 are adapted to fit a unit product sensing means configured with communication means, user interactive means, data storage means, reader means adapted to integrate with the said housing.

Yet another embodiment is described in FIG. 4. The device comprises of a housing 3 on which a sliding provision 1 having plurality of integrated deformable and pressable regions 6 is fitted in the said housing such that the said provision 1 reciprocates in the housing to effect controlled advancing of the said packaged unit dose/s. A spring loaded pressing means 2 is attached on the side surface of the housing 3. It has to be pushed for operating/sliding the said sliding provision 1. The packaged unit dose/s 5 is disposed in the top compartment of the said housing below the said sliding provision. In one of the variants, the packaged unit dose/s is blister package in the coil form. The bottom compartment is provided with openings (not shown) corresponding to each of the product in the said packaged unit dose/s. A passage 7 is provided to collect the dispensed product from the system. The dispensation operation needs pressing of the said pressing means 2 followed by sliding the said sliding provision 1 such that the said deformable regions are on the top of the packaged unit dose/s. Pressing the said regions dispenses the product from the packaged unit dose/s. Thus the product dispensing operation is not obvious to child to operate yet is senior friendly. In one of the embodiments said compartments are adapted to fit unit product sensing means configured with communication means, user interactive means, data storage means, reader means adapted to integrate with the said housing.

Yet another embodiment is described in FIG. 5. The device comprises of housing 2 provided with markings on the top corresponding to individual packaged unit dose/s. In one of the embodiments packaged unit dose/s is a blister strip. A roller 3 is disposed vertically in the said housing wherein a rotatable provision 1 in the form of a disc/dial is adapted to fit on the said roller outside the housing such that it engages with the said roller upon pressing/pushing down. The said roller is the controlled advancing means and the locking/unlocking is effected with the said disc/dial. The packaged unit dose/s 2 in the form of a strip is rolled over the said roller 3 as shown in the figure. The part of the packaged unit dose/s is dispensed from the opening 4 provided in the said housing. In operation one has to press the said rotatable provision 1 and further rotate the same to transmit the force to the roller and in turn to the said blister strip so as to dispense the packed-product from the said housing. Thus the product dispensing operation is not obvious to child to operate yet is senior friendly. In one of the embodiments said compartments are adapted to fit unit product sensing means configured with communication means, user interactive means, data storage means, reader means adapted to integrate with the said housing.

Yet another variant of this embodiment is described in FIG. 6. The device comprises of housing with compartment 1 adapted to receive a rotatable provision 2 on the top surface. A rotatable spindle 3 is disposed vertically between the said top compartment 1 and the bottom compartment 5 of the housing. The said rotatable provision has to be pressed to engage with the said spindle. The packaged unit dose/s 4 in the form of a ring is mounted on the said spindle 3 as shown in the figure. In one of the embodiments the packaged unit dose/s is a blister stripe. The said top compartment 1 is adapted to fit a pressing means 6. The said bottom compartment 5 is provided with openings corresponding to each of the product in the packaged unit dose/s. According to the markings the user has to rotate the said top compartment, press the said provision 1 to engage it with the said spindle, rotate the same and then press the said pressing means 6 to dispense the product from the packaged unit dose/s. Thus the product dispensing operation is not obvious to child to operate yet is senior friendly. In one of the embodiments said compartments are adapted to fit unit product sensing means configured with communication means, user interactive means, data storage means, reader means adapted to integrate with the said housing.

Yet another variant of this embodiment is described in FIG. 7. The device comprises of housing having top compartment and bottom compartment. The first pressing means 2 is adapted to fit on the top compartment and is in connection with the sliding provision 3 that is housed between the said two compartments. The blister pack is mounted on the said provision 3. The second pressing means 2 is provided on the bottom compartment and engaged with the said sliding means 3 such that user has to push both the pressing means to enable sliding of the said sliding provision and in turn packaged unit dose/s to dispense the packaged-product from the opening 6. Thus the product dispensing operation is not obvious to child to operate yet is senior friendly. In one of the embodiments said compartments are adapted to fit unit product sensing means configured with communication means, user interactive means, data storage means, reader means adapted to integrate with the said housing.

A further embodiment is described in FIG. 8. The device comprises of housing having first compartment 1 and second compartment 2 adapted to mount guide 9 for the packaged unit dose/s so as to coil the same around 9. In one of the embodiments the said packaged unit dose/s is blister package in stripe form. The packaged unit dose/s, in particular blister pack 3 shown as representation in the figure is coiled around the said guide 9. The means for advancing packaged unit dose/s comprises of a gear 5, roller 7 and ratchet 6 coaxially mounted on the shaft 8. The said gear 5 is engaged with a pressing means 4 wherein one of the ends of the said pressing means is pivoted at 10 in the said compartment 1. The other end of the said pressing means is provided with gear teeth wherein the pressing means is disposed so as to engage the said gear teeth with the said gear 5. From the end that is pivoted there is a concavely outwards surface 12 that is limited by the lower geared surface as shown in the figure. Part of the said protrudes out of the said compartment 1 and 2. The opening 13 is provide at the bottom portion of the said compartments. The free end of the said blister package rotatably engaged with the said roller wherein in operation pressing the said means 4, causes rotation of the said gear 5 thereby effecting the rotation of the said roller 7 resulting in advancement of the blister stripe to dispense from the said opening 13. The ratchet 6 restricts the rotation of the said gear in opposite direction. In one of the embodiments said compartments are adapted to fit unit product sensing means configured with communication means, user interactive means, data storage means, reader means adapted to integrate with the said housing.

In one of the embodiments of primary device is adapted to receive signals from diagnostic devices to collect data such as glucose, diabetic level, blood pressure level, pulse rate, heart rate, cholesterol, calories, alcohol level, ECG etc. In yet another variant of this embodiment the said primary device is adapted to communicate with USB/Bluetooth/Zigbee/Wibree based external multiple health monitoring devices such as glucose meter, diabetic meter, blood pressure meter, pulse rate meter, heart rate meter, cholesterol meter, calories meter, ECG

Monitor but not limited to it.

In one of the embodiments, the system configuration as depicted in FIG. 1 provides a means for authenticating a product package containing a product and two or more unique product identifers related to product package
the system comprising:
i) a multifunctional device comprising reader means for reading one or more of the unique product identifiers, communication means, and optionally one or more of dose sensing means for detecting information related to the product package, dose dispensing means, user interactive means and storage means; and
ii) a primary device in communication with the said multifunctional device comprising a communication means adapted to receive information related to the unique identifiers from the said multifunctional device and being capable of conveying the information to remote system or an external device
wherein the identity of the product package is verified to authenticate the same by providing the package with at least two sets of identification information comprising a first set of identification information and a second set of identification information, wherein at least one identification feature of the first set of identification information is arranged on or incorporated within a different surface, side or plane of the package, with respect to at least one identification feature of the second set of identification information, thereby adapting the package to be identified alternately the package is provided/affixed/attached with the identification tag that comprises at least two sets of identification information comprising a first set of identification information and a second set of identification information,
wherein said at least one identification feature of the first set of identification information and said at least one identification feature of the second set of identification information are arranged at a fixed relative spatial position with respect to each other, said fixed relative spatial position being used to derive a signature for identifying the package;
wherein the reader means comprises of one or more reading elements arranged to correspond to the position of each set of identification information on the package for reading the at least two sets of identification information;
wherein the said reader means is adapted to read a signal from the at least one identification feature of each of the at least two sets of identification
   information arranged on or incorporated within different surfaces, sides or planes of the package, and wherein the reading device is configured such that it defines the spatial relationship between a first discrete area of the first set of identification information to be read and a second discrete area of the second set of identification information to be read, and determining, using the reading device, at least one characteristic of a property of the at least one identification feature of the first set of identification features, thereby obtaining a first signal, determining, using the reading device, at least one characteristic of a property of the at least one identification feature of the second set of identification features, thereby obtaining a second signal, using a processing unit to derive/form/generate at least one signature for the object, using said first and said second signals (and thereby inherently or explicitly the features spatial relationship). The processing unit may further be adapted to update the pre-stored reference signature by storing data of a read signature as an updated pre-stored reference signature for a future verification check wherein it is not necessary that the pre-stored reference signature be stored permanently in the memory of a reading device; the reading device is adapted to receive the pre-stored reference signature that is stored in a remote data storage medium that can be accessed from a local area network (LAN) or a wide area network (WAN), such as the Internet, for example. Alternatively, the reading device may be able to receive the pre-stored reference signature that is stored in the package to which the tag is attached or the package to be identified. The reading device may thus also be adapted to read a conventional barcode, a twodimensional barcode, a magnetic strip or memory chip. In one of the variants the package or the tag may additionally have stored further information, for example, the price of the package, the manufacturer name thereof or the like. Such information may be included in a conventional bar code, a two-dimensional bar code, a magnetic strip or a memory chip.

Regardless of the type of identification information that is used, both the first and the second sets of identification information are arranged or contained within different sets of surfaces, sides or planes of the package/dispenser or on a tag or both. Several combinations of arrangements are possible. In one embodiment, the first set of identification information is arranged on a first surface of the package (such as the top surface) and the second set of identification information is arranged on a second surface of the package (such as the lateral surface or the bottom surface). For example, both the first and the second sets of identification information can be printed directly on a surface of a package, or both maybe printed on adhesive sheets and then affixed to the surface of the package. One implementation of such an arrangement in a tag that is to be used in conjunction with this method is a strip having at each end a set of identification features. Such a strip can be folded to form a loop for attachment to a part of a package.

In one of the embodiments the identification information may comprise an identification layer in which, at least in part, a plurality of randomly distributed particles is present. The randomly distributed particles may comprise a material that displays one or more consistently measurable physical properties, such as magnetic field strength, capacitance or conductance wherein “randomly distributed particles” includes voids, bubbles, or magnetic domains with a continuous material, or regions of varying reflectivity, or electrical properties. In one of the variants of this embodiment the identification layer comprises a plurality of randomly distributed magnetic or magnetisable particles derived from the elements Fe, Ni, Co, their alloys, oxides, mixtures and combinations thereof.

In yet another variant of this embodiment different types of identification information such as barcodes, magnetic tags, RFID tags, fluorescent particle tags and electrically conductive particle tags is used wherein the relative spatial position between identification features of different combinations of different sets of the said identification information can be used to identify the package, including but not limited to, combinations such as barcode-barcode, barcode-magnetic tag, barcode-fluorescent tag, magnetic tag-magnetic tag, magnetic tagfluorescent tag, and so on.

In another embodiment the identification tag comprises at least two sets of identification information comprising a first set of identification information and a second set of identification information. The first set of identification information and the second set of identification information are each arranged within a different surface, side or plane of the tag or object. Identification features of the first set of identification information and identification features of the second set of identification information are arranged at a fixed relative spatial position with respect to each other, said fixed relative spatial position being used to form/derive or generate the signature for identifying the object. In one embodiment, at least one set of identification information comprises an optically readable pattern. Any optically readable pattern can be used for this purpose, including any variety of printed symbols such as printed dots, a matrix of consecutive numbers, 1-dimensional barcodes, and 2 dimensional barcodes such as Aztec Code, Code 1, Code 49, PDF 417, QR Code, Super Code, and Ultra Code, for example.

In another variant of this embodiment, at least one of the first set of identification information and the second set of identification information is derived from at least one identification layer in which readable identification features are located. For this purpose, the identification layer may comprise a layer of any type of suitable material or combination of materials having one or more properties that are quantifiable in terms of a measurable physical quantity.

In yet another embodiment, the identification layer comprises a host material having pores, wherein at least some of the pores contain the particles. As explained below the particles may consist of a magnetic or magnetisable material or of a substantially electrically conducting material. In other embodiments, the particles may be randomly dispersed in a matrix or the particles may be provided by sputtering/ion implantation (cf. also Examples). By providing such a (highly) disordered structure with particles to define the identification features in the identification layer, the information can only be imitated with extremely high effort and/or cost thereby improving the security of the identification system. Any material exhibiting magnetic properties can be used in the identification layer, including but not limited to magnetic materials such as ferrimagnetic materials, antiferromagnetic materials and ferromagnetic materials. Magnetic materials used include but are not limited to ferromagnetic materials such as Fe, Ni, Co, Gd, Dy, the corresponding alloys, oxides and mixtures thereof, and other compounds such as MnBi, CrTe, EuO, CrO2 and MnAs. Other materials influenced by magnetism are also contemplated. Examples of such materials include ferrimagnetic materials e.g. spinels, garnets and ferrites such as magnetite. Other materials commonly used in magnetic media, such as alloys of Ce, Cr, Pt, B, Nd (e.g. Nd—Fe—B, Nd—Fe—Co—B, Nd—Pr—Fe—Co—Ti—Zr—B), Sm (e.g. SmCo5), and alloys such as, AlNiCo, Permalloy and MuMetal are also contemplated.

In one of the variants of this embodiment in order to support the magnetic particles, a supporting layer maybe arranged below the identification layer.

In a further embodiment, one or both of the sets of identification information is/are covered by a protective coating. In principle, every material that is suitable for physically protecting the identification information from damage (for example, by chemical and/or mechanical degradation) can be used, as long as this material does not prevent at least some of the identification features from being read. Examples of suitable material that can be comprised in the protective coating include, but are not limited to, polymeric coatings such as Teflon coating, a rigid polymer, a sol gel or vapour deposited material such as an oxide, nitride, amorphous diamond, a diamond-like material (film) such as diamond-like carbon, tetrahedral amorphous carbon or a spun-coated lacquer.

To authenticate the package in one of the embodiment the reading devices work as follows: when the device is brought up to the object, the barcode reading element senses that it positioned over a white reflective surface (i.e. it is positioned on the object before the start of the barcode). When the user swipes the reader across the package the barcode sensor senses the rapid changes between black and white regions which represent the beginning of the barcode. At this point the reading device's microprocessor (processing unit) is programmed to start acquiring (and storing) data from both the barcode sensor and the magnetic sensor.

In yet another variant of this embodiment the reading device is adapted to send the read signature to a remote device (such as a computer) that stores the prestored reference signature. That remote device compares the signatures and sends back a response identifying the item and providing any additional information that may be required. Often the actual reading device itself communicates with the remote device via a communication device (e.g. a cellular phone, a computer that is connected to the internet, or through a fixed line communication device). In this embodiment the remote device need not send a message back to the reading device itself, but rather the message may be sent back to the communication device which then displays the information to the user. For example, if the reading device communicates via a cellular phone, then the remote device need only send back a message to the cellular phone. The cellular phone may display the information to the user without sending any of the information back to the actual reading device itself.

In yet another variant of this embodiment, the identity of an object is authenticated or verified by matching the signature read from the object against pre-stored reference signatures stored on a database. In addition the verification may include checking individual signals obtained from readings of identification features of either set of identification information (i.e. matching a read magnetic signal against an authenticating magnetic signal) or checking any other information within the identification information (e.g. numerical meaning such as 0,1,2,3,4,5 to 9 assigned to various barcode patterns).

In yet another variant of this embodiment authentication may also be carried out wherein a signature from simultaneous readings of the first and the second set of identification information can be checked directly against the pre-stored reference signature without having to determine the area of overlap between read signature and the pre-stored reference signature. The pre-stored reference signature may be stored in any suitable data storage medium (typically a memory chip or hard disk drive) and most preferably accessed remotely using, any method that is suitable for this purpose, For example, remotely accessing the data storage medium can be carried out using the Internet (including mobile access such as General Packet Radio Service, GPRS, protocols), a fixed line access, a local area network, a bluetooth protocol, a short messaging service 5 (SMS) or a multimedia messaging service (MMS) signal, to name only a few possibilities.

In another embodiment the dose sensing means is a pressure sensor or may be based on resistance measurement or an accelerometer based on velocity measurement.

In one of the embodiments the said multifunctional device is adapted to fit on a package that is in the form of a bottle or pouch wherein the closure of the said package is removed. Further the said device dispenses product from the package wherein the device comprises of a dose dispensing means, dose sensing means, communication means, user interactive means, storage means, reader means. In one of the variants of this embodiment the said device comprises of a movable element that activates the said product sensing system upon dispensing of the product from the package.

In one of the embodiments the said multifunctional device communicates with the said primary device using modes such as RF, IR, wired and/or direct contact using protocols such as I2C, SPI, UART or combination thereof.

In yet another embodiment the said multifunctional device is adapted to receive signal from personalized/general diagnostic devices such as devices for measuring blood pressure, blood sugar, cholesterol, body temperature means.

Thus it is evident that the system comprising of a primary device working in conjunction with at least one multifunctional device provides packaged-product authentication, with optional product dispensation and recording of real-time product dispensation information, facilitates user compliance including appropriate patient feedback from clinical trials and/or collection of pharmacovigilance data and communication of product dispensation and user/product usage related information via the said primary device to external devices for information processing and management. Further such a synergistic functioning of the multifunctional device that functions as a reader, dispenser, sensor and recorder working in conjunction with the primary device obviates need of the use of signal generating means on the package corresponding to product containments as well as the signal sensing means within the device.

1. An interactive multifunctional system for use in authenticating a product package containing a product and information related to the product package, the system comprising:
i) a multifunctional device comprising:
reader means for reading unique identification information related to the product package, communication means, and optionally one or more of dose sensing means for detecting the presence of the product in the package, dose dispensing means, user interactive means and data storage means; and;
ii) a primary device in communication with the said multifunctional device comprising communication means adapted to receive information related to the product package from the said multifunctional device and being capable of conveying the information to a remote system or an external device.

2. An interactive multifunctional system for use in authenticating a product package containing a product and the presence of the product in the package comprising: i) a product, preferably a unit dose, in a package comprising one or a plurality of containments adapted to receive the product optionally with a closure, and unique identification information related to the product in the package ii) a multifunctional device comprising dose sensing means, dose dispensing means, communication means, and optionally one or more of reader means for reading information related to the product package, user interactive means and data storage means; and;
iii) a primary device in communication with the said multifunctional device comprising communication means adapted to receive information related to the product in the package from the said multifunctional device and being capable of conveying the information to a remote system or an external device.

3. An interactive multifunctional system as claimed in claim 1 for providing effective solution to anti-counterfeiting and providing compliance assistance to the end user comprising:
i) a product package comprising one or a plurality of containments adapted to receive a product optionally with a closure and the product package carrying identification information for verifying the identity of the product package;
ii) a system comprising;
a multifunctional device and a primary device in communication with the said multifunctional device
said multifunctional device comprising;
dose sensing means for detecting the presence of the product in the package;
reader means for detecting identification information carried by the product package, communication means for communicating information from the dose sensing means and/or reader means to the primary device, dose dispensing means adapted to provide controlled dispensation of a plurality of packaged unit dose(s); and
said primary device comprising;
communication means adapted to receive information related to the product package and/or the presence of the product in the package from the said multifunctional device and optionally adapted to convey the said information to a remote system or an external device
wherein optionally one or more of the multifunctional device, remote system or external device comprises, one or more of a data storage means, data processing means and user interactive means.

4. An interactive multifunctional system as claimed in claim 1 wherein the identification information is present in or on a tag on the product package
wherein the identification information comprises two or more identifiers, a first identifier comprising a readable layer of randomly distributed material which is capable of encoding identification information and a second identifier comprising optical information
wherein the two or more identifiers are unique to the package and are recorded in the primary device, the multi-functional device or an external device or remote system with which the primary device is communicable, such that, in use, on bringing the product package into proximity with the multi-functional device, the reader means detects the presence or absence of the unique identifiers on the product package, conveys information relating to the unique identifiers to the primary device and optionally to a remote system or external device wherein the acquired information from the product package is compared with that recorded so as to verify or authenticate the product package.

5. An interactive multifunctional system as claimed in claim 1 wherein the multifunctional device and the primary device are contained in a single housing.

6. An interactive multifunctional system as claimed in claim 1 wherein the information in or on the product package comprises two or more identifiers, the reader means comprises one or more reading elements arranged to read each identifier on the product package; and wherein the reading device is configured such that the spatial relationship between a first discrete area of the first identifier and a second discrete area of the second identifier is detectable to provide a read signature for the package the system further comprising or being communicable with a processing unit having a pre-stored reference signature and being adapted to update the pre-stored reference signature by storing data of the read signature as an updated pre-stored reference signature for a future verification check
wherein the reading device is adapted to receive the pre-stored reference signature from the processing unit.

7. An interactive multifunctional system as claimed in claim 1 wherein the primary device comprises a wired or wireless communication means, a data storage and data processing means, user interactive means adapted to receive information from the said multifunctional device and/or to receive user feedback on the effects of the medication.

8. An interactive device as claimed in claim 7 wherein the user interactive means is adapted to receive information relating to clinical trials; from a diagnostic device to collect data relating to one or more of the user glucose level, diabetic level, blood pressure level, pulse rate, heart rate, cholesterol, calories or alcohol level; ECG research and/or pharmacovigilance and optionally to convey the information to an external device or remote system.

9. An interactive multifunctional system as claimed in claim 1 wherein the multifunctional device comprises a first movable elongate member hinged to a second optionally movable elongate member
wherein the said first member has a protrusion at the end opposite to the hinged end under the surface that faces the second elongate member; a reader means adapted to read and acquire information related to the product package, communication means, data storage means, user interactive means; the said second member comprises an opening disposed at the end opposite to the hinged end corresponding to the protrusion of the first member, with an optional conduit following the said opening, an outlet to the said conduit; sensing means disposed on the said first elongate member or in/along the said conduit;
wherein the said package when positioned between the said members allows the location of the product containment of the package below the protrusion of the said first member; thereby on application of appropriate force on the end provided with protrusion of the said first elongate member, dispensing the product from the containment of the package optionally into the conduit through the said opening of the said second member; wherein the said sensing means senses and records the real time product dispensation.

10. An interactive multifunctional system as claimed in claim 1 wherein the multi-functional device comprises a dispenser housing adapted to contain packaged unit doses; a means for controlled advancing of the said packaged unit doses, such as a rail, pathway, channel or lamina; optionally a means to force the product unit dose out of the said package to dispense the same; an opening for guiding and dispensation of the said product unit dose or the product;
a means for locking the advancement of the product unit doses in the said advancement means, a means for unlocking the advancement of the product through the said advancement means ; optionally unit product dose sensing means configured with communication means, user interactive means, data storage means, reader means adapted to integrate in the said housing of the system.

11. An interactive multifunctional system as claimed in claim 1 wherein the multifunctional device comprises
a housing on which a sliding provision having plurality of integrated deformable and pressable regions is fitted in the said housing such that the said provision reciprocates in the housing to effect controlled advancing of the said packaged unit dose/s;
a spring loaded pressing means attached on the side surface of the housing wherein the spring loaded means is to be pushed for operating/sliding the said sliding provision;
wherein the packaged unit dose/s is disposed in the top compartment of the said housing below the said sliding provision;
wherein the bottom compartment is provided with openings corresponding to each of the product in the said packaged unit dose/s, a passage provided to collect the dispensed product from the system
wherein the said compartments are adapted to fit unit product sensing means configured with communication means, user interactive means, data storage means, reader means adapted to integrate with the said housing

12. An interactive multifunctional system as claimed in claim 1 wherein the multifunctional device comprises a housing provided with markings on the top corresponding to individual packaged unit dose/s; a roller that is disposed vertically in the said housing wherein a rotatable provision in the form of a disc/dial is adapted to fit on the said roller outside the housing such that it engages with the said roller upon pressing/pushing down; wherein the said roller is the controlled advancing means and the locking/unlocking is effected with the said disc/dial; the packaged unit dose/s in the form of a strip is rolled over the said roller wherein part of the packaged unit dose/s is dispensed from the opening provided in the said housing, wherein the said compartments are adapted to fit unit product sensing means configured with communication means, user interactive means, data storage means, reader means adapted to integrate with the said housing.

13. An interactive multifunctional system as claimed in claim 1 wherein the multifunctional device comprises a housing with a top compartment adapted to receive a rotatable provision on the top surface; a rotatable spindle is disposed vertically between the said top compartment and the bottom compartment of the housing wherein
the said rotatable provision has to be pressed to engage with the said spindle;
the packaged unit dose/s in the form of a ring is mounted on the said spindle;
the said top compartment is adapted to fit a pressing means wherein the said bottom compartment is provided with openings corresponding to each of the product in the packaged unit dose/s;
wherein according to the markings the user has to rotate the said top compartment, press the said provision to engage it with the said spindle, rotate the same and then press the said pressing means to dispense the product from the packaged unit dose/s;
wherein the said compartments are adapted to fit unit product sensing means configured with communication means, user interactive means, data storage means, reader means adapted to integrate with the said housing.

14. An interactive multifunctional system as claimed in claim 1 wherein the multifunctional device comprises
a housing having a top compartment and a bottom compartment, first pressing means adapted to fit on the top compartment and in connection with a sliding provision housed between the said top and bottom compartments and wherein the provision is adapted to receive a blister pack; a second pressing means provided on the bottom compartment engagable with the said sliding provision such that the sliding provision is advanced on pressing both the pressing means such that a packaged unit dose/s is dispensed from the top or bottom compartment;
and wherein the at least one compartment is adapted to fit unit product sensing means configured with communication means, user interactive means, data storage means, reader means adapted to integrate with the said housing.

15. An interactive multifunctional system as claimed in claim 1 wherein the multifunctional device comprises
a housing having first compartment and second compartment adapted to mount a guide for a blister pack which comprises at least one unit dose so as to coil the packaged unit dose same around the said guide;
means for advancing the packaged unit dose comprising a gear, roller and ratchet coaxially mounted on a shaft;
wherein the said gear is engagable with a pressing means wherein one of the ends of the said pressing means is pivotable in the said compartment; the other end of the said pressing means is provided with gear teeth wherein the pressing means is disposed so as to enable engagement of the said gear teeth with the said gear;
opening is provide at the bottom portion of the said compartments;
wherein the roller is rotatably engageable with the free end of the said blister package rotatably such that, in use, pressing the said pressing means, causes rotation of the said gear thereby effecting the rotation of the said roller resulting in advancement of the blister stripe package to dispense a unit dose from the said opening;
wherein at least one of the said compartments are adapted to fit unit product sensing means configured with communication means, user interactive means, data storage means, reader means adapted to integrate with the said housing.

16. An interactive multifunctional system as claimed in claim 1 wherein the multifunctional device comprises
a dispenser housing that is divided in a top and bottom compartment; a packaged unit dose/s controlled advancing means in the form of a rotatable lamina is adapted to fit between the said compartments such that it can rotate independently wherein the said lamina is provided with information relating to the time/date of product consumption along the periphery;
the said top compartment is provided with a spring loaded pressing means such that it can be aligned on the top of the individual blister wherein the bottom compartment is provided with an opening for dispensing the product from the blister package;
wherein the said two compartments and the said lamina are rotated in tandem with each other;
wherein the said top an/or bottom compartment is adapted to fit a unit product sensing means configured with communication means, user interactive means, data storage means, reader means adapted to integrate with the said housing.
